(19) United States
(12) Patent Application Publication
(10) Pub. No.: US 2017/0290647 A1
(43) Pub. Date: Oct. 12, 2017

(54) Pacifier to Prevent or Reduce Early Childhood Caries

(71) Applicant: Derek Brian Tom, Honolulu, HI (US)

(72) Inventor: Derek Brian Tom, Honolulu, HI (US)

(21) Appl. No.: 15/152,490

(22) Filed: May 11, 2016

Related U.S. Application Data
(60) Provisional application No. 62/321,648, filed on Apr. 12, 2016.

(51) Int. Cl. A61C 17/02; A61J 17/00

(52) U.S. Cl. CPC A61C 17/02; A61J 17/006

(57) ABSTRACT

A pacifier for rinsing an infant's or child's mouth and teeth having an aperture extending through its front lip shield and connecting to a port near the front of the pacifier. The port preferably connects the aperture to enclosed channels or tubes preferably contained entirely within the body walls of the pacifier. The enclosed channels or tubes allow fluid communication with beveled openings located on the top side of the pacifier. The beveled openings are preferably forwardly angled to point towards the lip shield and the interior surface of the infant's or child's upper teeth when the pacifier is placed in the infant's or child's mouth so that when water is pushed through the aperture, the water is pushed through the port, the enclosed channels, and out of the beveled openings, and rinses the mouth and teeth.

This application claims the benefit of U.S. provisional patent application No. 62/321,648 filed Apr. 12, 2016.

### TECHNICAL FIELD

The present invention generally relates to devices for cleaning or rinsing the teeth of infants and young children. More specifically, it relates to a pacifier or other device that can rinse the teeth of infants and young children after nursing or feedings.

### BACKGROUND ART

Early childhood caries (ECC), also known as baby bottle caries (decay), baby bottle tooth decay, and bottle rot, is a disease characterized by severe decay in the teeth of infants and young children caused by nursing or bottle feeding with a fermentable carbohydrate (for example, breast milk, milk, formula or juice) before bedtime and/or in the middle of the night, without subsequent rinsing of the mouth and teeth. Nursing or bottle feeding at night is common because it provides a soothing effect that can put children to sleep, or back to sleep, when they wake up in the middle of the night. However, milk, for example, contains a sugar called lactose, which turns into acid when digested by the bacteria in the mouth, in particular streptococcus mutans. If milk or other sugary liquids are left clinging to an infant or child's teeth for long periods of time, the resulting acid will eventually cause decay. Thus, once an infant or child has teeth, night time feedings or middle of the night feedings can put a child at risk of developing ECC, which causes rampant tooth decay and can commonly lead to dental infections, which can be life threatening if left untreated.

The teeth most commonly affected by ECC are the upper (maxillary) front four teeth and upper first molars. The lower (mandibular) teeth are not as affected because a mother's nipple or bottle nipple is normally situated between the tongue and palate (roof of the mouth) so that milk does not reach the lower teeth as easily. Saliva from a salivary gland located under the tongue also provides some rinsing for the lower teeth. ECC can occur anywhere on the teeth, including both the front and back surfaces, but mostly occurs where the teeth touch one another and near the gum line.

The American Academy of Pediatric Dentistry (AAPD), the recognized authority on children's oral health, recommends that children be seen by a pediatric dentist by one year of age, to give the pediatric dentist the opportunity to stress to parents the importance of early intervention to prevent ECC. On average, an infant's first tooth erupts at about six (6) months of age, and most infants are still being put to bed with milk at this age. Pediatric dentists try to explain and educate parents about ECC and attempt to motivate them to stop nighttime or middle of the night feedings. The reality however is that parenting is physically and emotionally tiring and most parents will do anything to get their child to sleep, or to go back to sleep, even if it means giving their child milk before bedtime or in the middle of the night, without subsequent rinsing of the child's teeth and mouth. This is the reason why ECC is so prevalent across the world and why education about ECC is not enough to cure the problem. The only real cure for ECC is to rinse or clean milk (or other fermentable liquid) off an infant or young child's teeth to prevent bathing the teeth in sugars and bacteria in the mouth throughout the night.

There are pacifiers in the prior art that direct liquids to pass through a pacifier's nipple; however, they are typically designed to avoid the tasting of bitter medications, rather than being aimed at rinsing or cleaning the teeth. They do this by having an aperture (opening) on the very end (tip) of the nipple, to allow bitter tasting medications or vitamins to bypass the taste buds on the tongue before being ingested.

For example, U.S. Pat. No. 5,662,684 to Caso for a “Liquid Dispensing Pacifier Apparatus,” incorporated herein by reference, discloses a liquid dispensing pacifier comprising a body having a proximal end and a distal end, and a nipple base defining the proximal end. A resilient nipple is affixed to and extends outward from the nipple base. An aperture base defines the distal end of the body, and an aperture is affixed to and extends from the aperture base. A reservoir is located within the body, and is in fluid communication with the resilient nipple. A plurality of pleats is disposed along the body, which permits the body to collapse and compress in response to an infant withdrawing fluid from the reservoir via the resilient nipple.

For another example, U.S. Pat. No. 5,127,903 to Mailot et al. for a “Device for Dispensing Medicaments to Infants,” incorporated herein by reference, discloses a device for delivering medicaments (medicines) to infants by means of a dispenser in a pacifier. The dispenser regulates the rate of medicament released by using semipermeable membranes or capillary tubes. As the child or infant suckles on the pacifier, a flow of saliva bathes the dispenser and mixes with the dispensed medicaments.

There are other pacifiers in the prior art which have apertures located on the top of the pacifier nipple instead of at the tip. For example, U.S. Pat. No. 6,126,678 to Aaltonen et al. (“Aaltonen”) for an “Intraoral Administration Device,” incorporated herein by reference, discloses an administration device for a method to prophylactically treat the mouth region of children. The device comprises a part intended to be positioned in the mouth, which part is provided with a dispensing container for an active agent (such as fluoride or xylitol), and having at least one aperture near the front (shield) allowing the entrance of saliva into the dispensing container and its exit therefrom, and a part to remain outside the mouth, comprising a hand held member, whereby a filler opening concentrically opening towards the hand held member, is arranged in the area between both parts. Two apertures located on the top of the pacifier nipple serve as an entry point for saliva to enter and mix with the active agent. The mixture of the saliva and the active agent then exits out of the same holes to cleanse the “mouth region or throat.” There are however some major flaws with the Aaltonen device. First, it is reliant on a child sucking on the pacifier for a significant amount of time in order to produce an adequate supply of saliva to enter the apertures, mix with the active agent and exit. With only minor salivary glands located on the palate (which is the area adjacent to the apertures on the Aaltonen pacifier nipple) only a minimal or unpredictable amount of saliva may be available to mix with the active agent. Second, not all children will suck on a pacifier so that the device can provide its cleansing function. Third, even if an adequate amount of saliva is produced and mixed with the active agent, most if not all of the cleansing solution will be swallowed and ingested when the child sucks on the pacifier, rather than used to cleanse the child's teeth.

Accordingly, it is an object of the present invention to provide a pacifier that functions as a cleansing or rinsing device and allows an infant, toddler or young child's teeth to be rinsed with water after nursing, bottle use, or the consumption of any fermentable carbohydrate, to reduce the likelihood of developing ECC.

It is another object of the present invention to provide a pacifier that also functions as a soothing device with an orthodontically shaped nipple that does not completely deflate or collapse upon sucking.

It is still another object of this invention to provide a pacifier that it not reliant on a child sucking the pacifier to provide its cleansing or rinsing effect.

It is a further object of the present invention to provide a pacifier that does not require a certain amount of saliva in order to provide its cleansing or rinsing effect.

### SUMMARY OF THE INVENTION

The above and other objects are preferably achieved by a pacifier consisting of typical pacifier parts: a handle, a plastic lip shield, a body having a top side (top), a bottom side (bottom), a front side (front), a back side (back), body walls with an outer surface (typically made of silicone) surrounding and defining an inner lumen, and nipple shaped teat. The lip shield preferably is mounted on the front, and the nipple is preferably mounted on the back.

In one presently preferred embodiment of the invention, the pacifier preferably contains an aperture (opening) on its front lip shield. The aperture extends through the lip shield and connects to a port near the front of the pacifier. The port connects the aperture to the enclosed channels or tubes. The enclosed channels or tubes are preferably entirely contained entirely within the body walls, or located entirely on the outer surface of the body walls. In the case where the enclosed channels or tubes are entirely within the pacifier body walls, the port is located on a portion of the outer surface of the body wall near the front of the pacifier and extends into (but not through) the body wall to connect the aperture to the enclosed channels or tubes. The beveled openings also extend through the outer surface of the body walls, but the port, the enclosed channels, and the beveled openings do not extend through the body walls into the inner lumen. The enclosed channels or tubes allow fluid communication with strategically placed beveled openings (forwardly angled) on the top side (top) of the body. Enclosed channels and tubes, as referred to herein, are preferably enclosed channels or tubes, but can be any other structure that can provides the function of fluid communication. The beveled openings on the top are preferably forwardly angled to point towards the lip shield and the interior surface of the child's upper teeth (the area most commonly affected by ECC) when the pacifier is placed in the child's mouth. A syringe is preferably pre-filled with water and its tip inserted into the aperture. Positive pressure applied to the water-filled syringe will preferably force water through the aperture, the port, the enclosed channels or tubes, and out through the beveled openings (forwardly angled) on the top side of the body, thereby cleansing or rinsing the teeth, as well as the soft tissue, palate and tongue. The child does not need to suck on the pacifier in order for the water to rinse the teeth, nor is a certain amount of saliva necessary to activate the cleansing or rinsing effect of the device. The nipple of the pacifier is also preferably shaped in a way to reduce the chances of affecting an infant, toddler or young child's dentition, such as by creating openbites (overbites or the extent of vertical overlap of the maxillary central incisors over the mandibular central incisors, measured relative to the incisal ridges) or crossbites (a form of malocclusion (misalignment) where a tooth is either closer to the cheek or to the tongue than its corresponding antagonist tooth in the upper or lower dental arch), which can lead to more severe problems such as jaw problems, speech issues and tongue thrusts. Tongue thrusts are a human behavioral pattern in which the tongue protrudes through the anterior incisors during swallowing, speech, and while the tongue is at rest.

The presently preferred embodiment of the invention is especially useful at night when children rely on drinking milk to soothe themselves to sleep. After the child drinks milk, the pacifier can be gently inserted into the child's mouth, and with positive pressure applied to the water filled syringe, the child's teeth will be rinsed with water. It would be preferably to hold the child no less than 45 degrees while using the device, or at least at the same angle that the child is being nursed at or using the bottle, to avoid fluid being aspirated into the lungs of the child.

The enclosed channels or tubes preferably branch out and exit at different locations on the top the body so that the device can preferably rinse multiple areas within a child's mouth. The enclosed channels or tubes preferably are located entirely within the body walls, or entirely on the top or bottom outer surface of the body walls. The beveled openings may extend through the outer surface of the body walls, but the port, the enclosed channels (and their branching), and the beveled openings do not extend through the body walls into the inner lumen. The fact that the enclosed channels or tubes (and their branching) do not penetrate (extend entirely through) the body walls, allows the device to have the same soothing effect as a normal pacifier because suction or sucking does not completely collapse or completely deflate the body. In contrast, the pacifier in Aaltonen collapses or deflates upon sucking because its cleansing holes penetrate (extend entirely through) the body walls, thereby completely collapsing or completely deflating the shape of the pacifier teat upon sucking.

The ability to apply positive pressure to the syringe allows the device to rinse a child's teeth while a child is awake, or after the child has fallen asleep, because sucking is not required to effect the rising or cleansing action of the device. On the other hand, sucking and saliva production is required for the Aaltonen pacifier to provide its cleansing function.

The presently preferred embodiment of the invention can also be manufactured in different sizes with different sizes of teats to accommodate children of different ages, and their different size mouths and number of teeth, with larger pacifiers preferably having more beveled openings on the body walls, to ensure proper rinsing of the increased number of teeth. The enclosed channels or tubes are preferably designed to rinse the maxillary (upper) teeth, but additional beveled openings (forwardly angled) on the lateral (side) and ventral (bottom) surfaces of the body walls can optionally be added to rinse the upper molars and tongue respectively.

The body and nipple are also preferably made out of silicone, not latex, to avoid any complications with latex allergies.

The presently preferred embodiment of the invention is a pacifier for rinsing an infant's or child's mouth and teeth comprising: a body preferably having a top side (top), a bottom side (bottom), a front side (front) having a port, a back side (back), body walls preferably having an outer surface with beveled openings along the body walls that are preferably angled toward the front, and enclosed channels preferably in fluid communication between the port and the beveled openings; a lip shield preferably mounted on the front having an aperture extending through the lip shield to connect to the port, wherein the lip shield and the body walls surround and define an inner lumen; and a nipple preferably mounted on the back; whereby when the pacifier is placed in the mouth, and water is pushed through the aperture, the water is preferably pushed through the port, the enclosed channels and the beveled openings, and rinses the teeth. The pacifier has an optional tube preferably attached to the aperture in the front.

The presently preferred embodiment of the invention is also a pacifier for rinsing an infant's or child's mouth and teeth comprising: a body preferably having a top, a bottom, a front having a port, a back, body walls preferably having an outer surface with a first notch preferably configured to receive the teeth along the body on the top with beveled openings in the first notch that are preferably angled toward the front, and enclosed channels preferably in fluid communication between the port and the beveled openings; a lip shield mounted on the front having an aperture extending through the lip shield to connect to the port, wherein the lip shield and the body walls surround and define an inner lumen; and a nipple mounted on the back; whereby when the pacifier is placed in the mouth, and water is pushed through the aperture, the water is preferably pushed through the port, the enclosed channels and the beveled openings, and rinses the teeth. The pacifier has an optional tube preferably attached to the aperture in the front. A second notch preferably configured to receive the teeth is preferably located along the bottom of the body.

The presently preferred embodiment of the invention is also a pacifier for rinsing an infant's or child's mouth and teeth comprising: a body preferably having a top, a bottom, a front having a port, a back, body walls preferably having an outer surface with beveled openings along the body walls that are preferably angled toward the front, and enclosed channels preferably in fluid communication between the port and the beveled openings; a lip shield preferably mounted on the front having a bulb connected to the port, wherein the lip shield and the body walls surround and define an inner lumen; and a nipple preferably mounted on the back; whereby when the pacifier is placed in the mouth, the bulb is filled with water, and the water is squeezed through the port, the enclosed channels and the beveled openings, the water rinses the teeth.

For any of the above described preferred embodiments, the enclosed channels can preferably be located entirely within the body walls, or they can be located entirely on the outer surface, with the beveled openings on the top or the bottom. If they are entirely within the body walls, then the port preferably extends through the outer surface into the body walls and connects to the enclosed channels, and the beveled openings extend through the outer surface of the body walls. However, the port, the enclosed channels, and the beveled openings do not extend through the body walls into the inner lumen. The enclosed channels are preferably branched into a branching pattern selected from the group consisting of: semi-circular convex pattern, semi-circular concave pattern, quaternary pattern, and quinary pattern. The lip shield can be integrally formed with the body, and the nipple is preferably made out of silicone.

The presently preferred embodiment of the invention is also a baby bottle cap for rinsing an infant's or child's mouth and teeth comprising: a body preferably having a top, a bottom, a front having a port, a back, body walls preferably having an outer surface with beveled openings along the body walls that are angled toward the front, and enclosed channels preferably in fluid communication between the port and the beveled openings; a nipple preferably mounted on the back; and a rim preferably configured to retain the cap having an aperture extending through the rim to connect to the port, wherein the rim and body walls define an inner lumen; whereby when the cap is placed in the mouth, and water is pushed through the aperture, the water is preferably pushed through the port, the enclosed channels and the beveled openings, and rinses the teeth.

The enclosed channels in the baby bottle cap can be preferably located entirely within the body walls, or they can be entirely on the outer surface, with the beveled openings on the top or the bottom. If they are located entirely within the body walls, the port preferably extends through the outer surface into the body walls, and connects to the enclosed channels, and the beveled openings also preferably extend through the outer surface of the body walls. However, the port, the enclosed channels or tubes, and the beveled openings do not extend through the body walls into the lumen. The enclosed channels are preferably branched into a branching pattern selected from the group consisting of: semi-circular convex pattern, semi-circular concave pattern, quaternary pattern, and quinary pattern. The nipple is preferably made out of silicone.

The presently preferred embodiment of the invention is also a device for rinsing an infant's or child's mouth and teeth comprising: a retainer configured to receive the teeth preferably having a top, a bottom, a front having a port, a back, retainer walls preferably having an outer surface with openings along the retainer walls facing the top, and enclosed channels in fluid communication between the port and the openings; and a lip shield mounted on the front preferably having an aperture extending through the lip shield to connect to the port; whereby when the retainer is placed in the mouths, and water is pushed through the aperture, the water is preferably pushed through the port, the enclosed channels and the openings, and rinses the teeth.

The enclosed channels in the device are preferably located entirely within the retainer walls, or on the outer surface of the retainer walls, with the beveled openings on the top. If they are entirely within the retainer walls, then the port preferably extends through the outer surface into the retainer walls and connects to the enclosed channels, and the beveled openings extend through the body walls and through the outer surface in the top. The enclosed channels are preferably branched into a branching pattern preferably selected from the group consisting of: semi-circular convex pattern, semi-circular concave pattern, quaternary pattern, and quinary pattern.

### BRIEF DESCRIPTION OF DRAWINGS

FIG. 1 is a perspective view from the front of a first embodiment of the invention, together with a removable plastic syringe that inserts into an aperture in the lip shield of the pacifier.

FIG. 2 is an elevational side view of the embodiment in FIG. 1.

FIG. 3 is a perspective view from the rear of the embodiment in FIG. 1, showing the beveled holes on the top of the body wall.

FIG. 4A is a front perspective view of the embodiment in FIG. 1, showing the aperture into which the removable syringe is inserted.

FIG. 4B is a detailed view of an alternate embodiment of the lip shield, in which the syringe can be inserted into external tubing attached to the lip shield, instead of an aperture in the lip shield.

FIG. 5 is a top plan view of the pacifier.

FIG. 5A is an enlarged top view of area 5A in FIG. 5.

FIG. 6 is a top plan view of a first alternative embodiment with a different branching pattern.

FIG. 7 is a top plan view of a second alternate embodiment showing the enclosed channels or tubes on the top surface of the body and with a second alternate design for the branching of the enclosed channels or tubes.

FIG. 8 is a cross sectional view from the side of the pacifier teat of FIG. 2, illustrating the direction of water movement when positive pressure is applied to the syringe.

FIG. 9 is an enlarged elevational view from the side of the pacifier, illustrating one enclosed channel and its beveled opening.

FIG. 10 is another top plan view of the pacifier, showing another alternate design for the branching of the enclosed channels or tubes.

FIG. 11 is another top plan view of the pacifier, showing still another alternate design for the branching of the enclosed channels or tubes.

FIG. 12 is a cross sectional view of the pacifier in FIG. 11 along the line 12-12, showing the enclosed channels or tubes embedded in the walls of the pacifier teat.

FIG. 13 shows another alternative embodiment of the invention in the form of a baby bottle cap.

FIG. 14A shows a side elevational view of another alternative embodiment of the invention.

FIG. 14B is an enlarged cross sectional view of FIG. 14A along the line 14B-14B.

FIG. 15 is an elevational view from the side of another alternative embodiment of the invention.

FIG. 16 is a top plan view of the embodiment of FIG. 15.

FIG. 17 is another alternative embodiment of the invention that uses a squeeze bulb instead of a syringe.

### BEST MODE FOR CARRYING OUT THE INVENTION

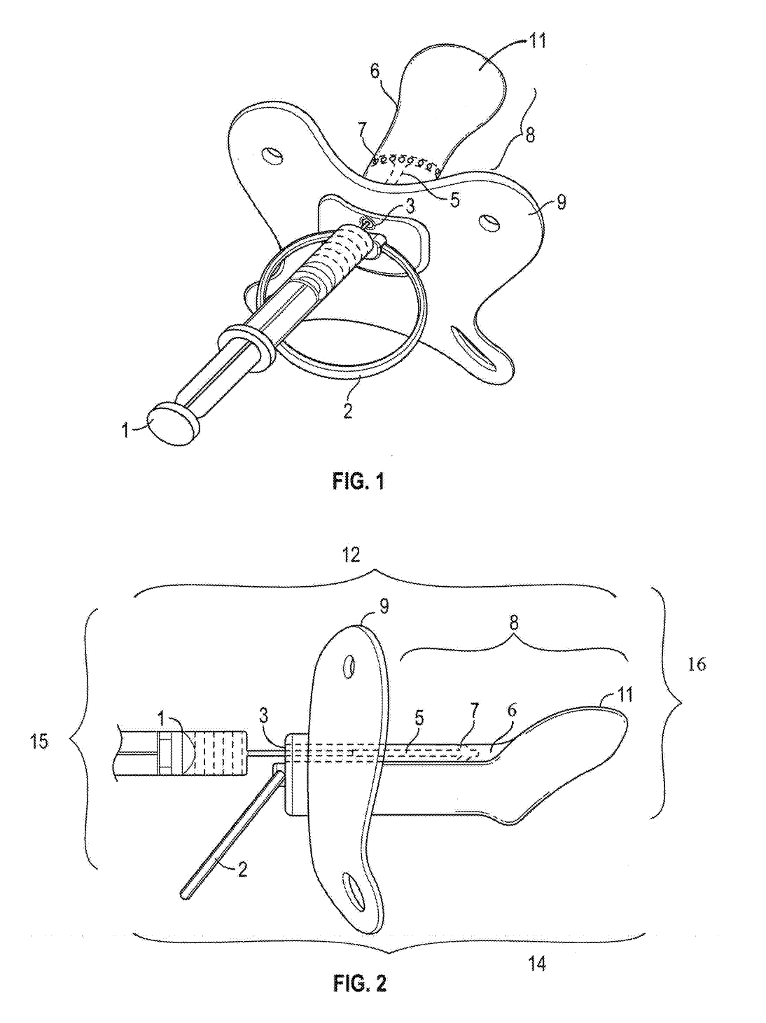

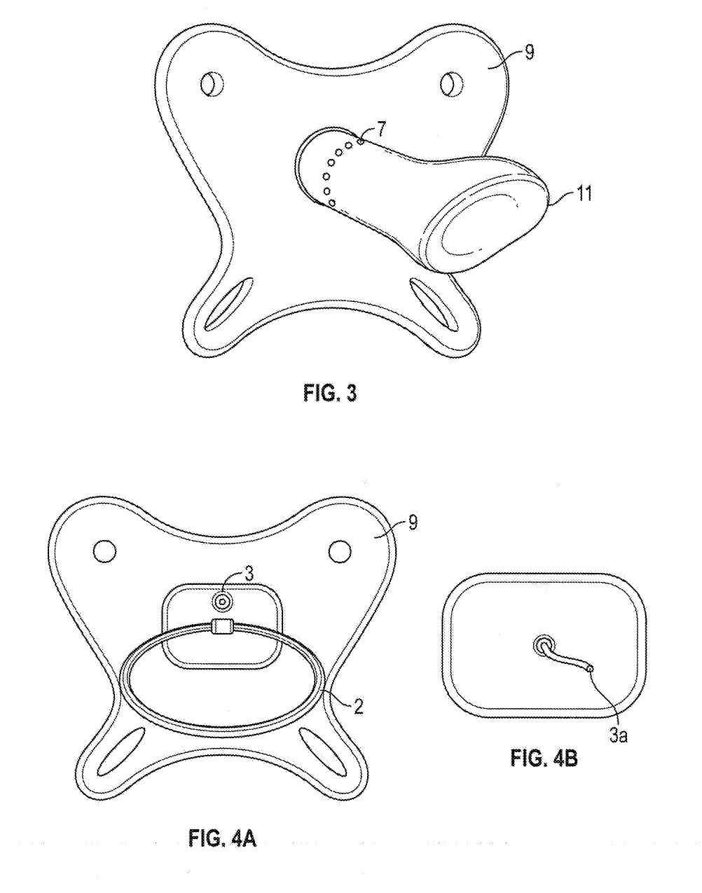

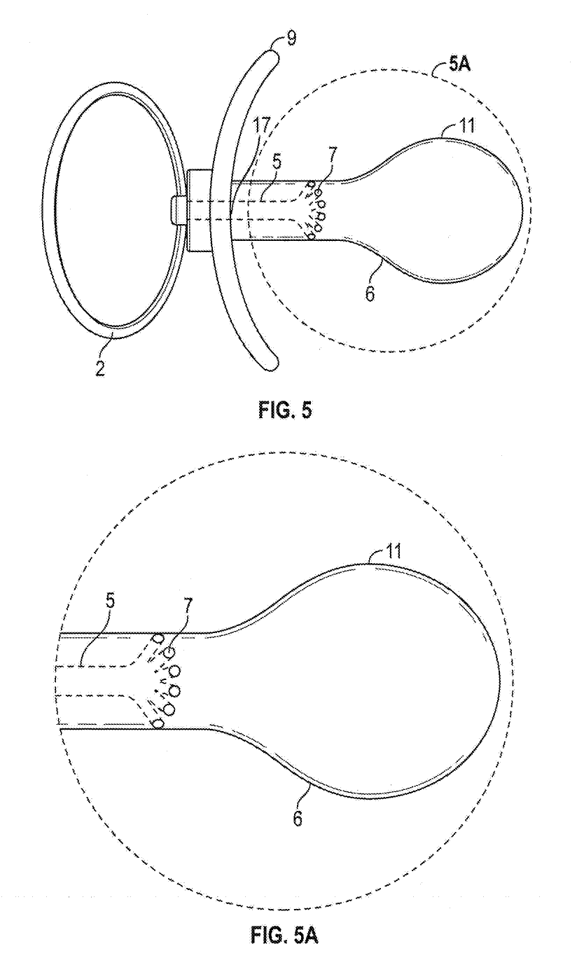

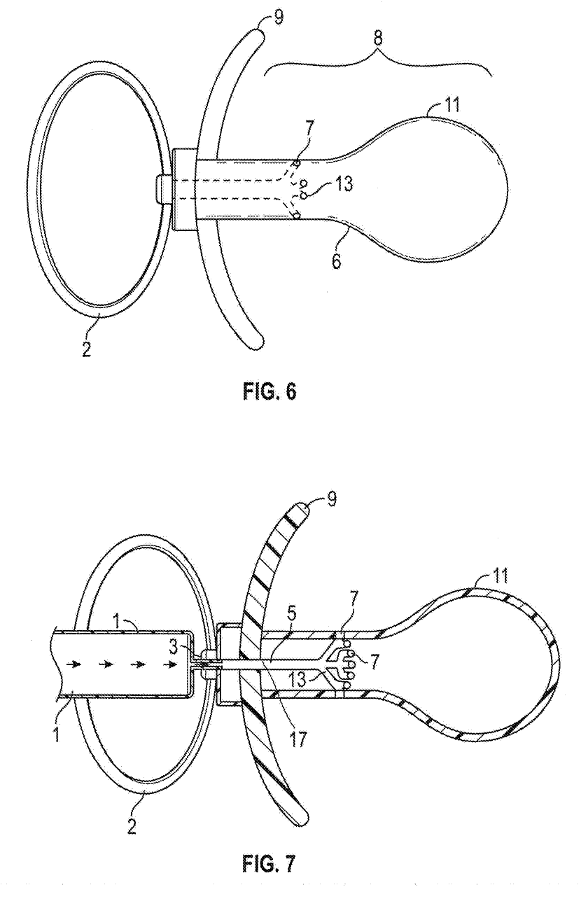

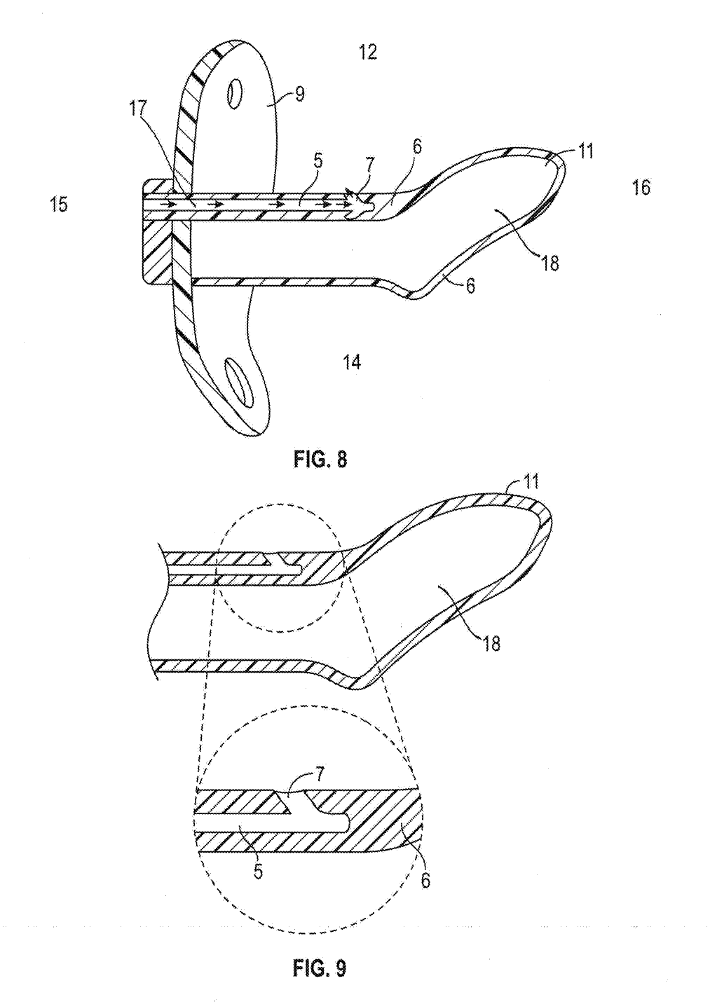

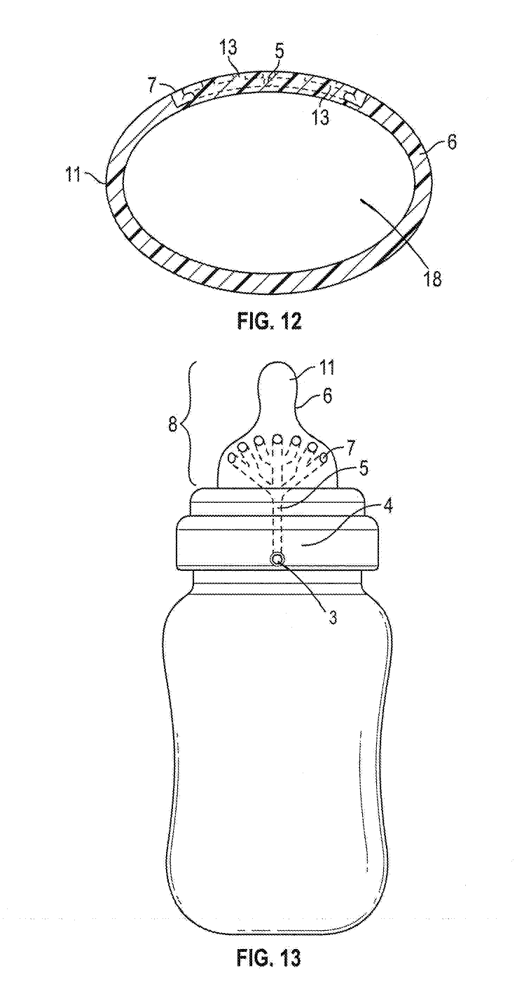

The presently preferred best modes for carrying out the present invention are illustrated by way of example in FIGS. 1-16. Referring to FIGS. 1-11, shown is a first presently preferred embodiment of the invention comprising a pacifier having a body 8 with top side (top) 12, a bottom side (bottom) 14, a front side (front) 15 having a port 17 (shown in FIGS. 5, 7, and 8), a back side (back) 16, body walls 6 having an outer surface with beveled openings 7 along said body walls 6 that are angled toward the front 15, and enclosed channels 5 in fluid communication between the port 17 and the beveled openings 7. The enclosed channels or tubes 5 are preferably located entirely within the body walls as shown in FIGS. 6, 8, 9, and 12, for example, or entirely on the external surface of the body walls 6 as shown in FIG. 7. A lip shield 9 is mounted on the front 15 and has an aperture 3 that extends through the lip shield and connects to a port 17 as shown in FIG. 7. The lip shield 9 and the body walls 6 together define an inner lumen 18 (shown in FIGS. 8 and 9). A nipple 11 is mounted on the back 16, and an optional handle 2 can be mounted on the lip shield in the front 15.

A plastic syringe 1 that is filled with water is preferably inserted into an aperture 3 in the lip shield 9. The syringe 1 is a separate device that is not part of the pacifier. Its main purpose is to push water through the aperture 3, the port 17, and the enclosed channels or tubes 5 so that it can exit at beveled openings 7 located along the body walls 6 near a child's upper teeth when the device is inserted into a child's mouth. The beveled openings 7 are forwardly angled (as shown in FIGS. 8 and 9) so that water is preferably directed forwardly toward the lip shield 9 and the interior surface of a child's upper teeth. The syringe 1 preferably can be inserted into the aperture 3 or a tube 3a (shown in FIG. 4B) located in the lip shield 9. FIG. 8 illustrates the flow of water through the enclosed channels or tubes 5 and shows the beveled openings 7 in the body walls 6 angled to direct water towards the front 15. The enclosed channels or tubes 5 can either be preferably located entirely on the outer surface of the body wall 6, as shown in FIG. 7, with the beveled openings being on the top 12 or bottom 14, or entirely inside (within) the body wall 6 itself as shown in FIG. 9, for example. The enclosed channels or tubes 5 do not extend through the body walls 6 into the inner lumen 18. All the enclosed channel or tube 5 locations result in water flowing out of the body 8 to provide a rinsing effect.

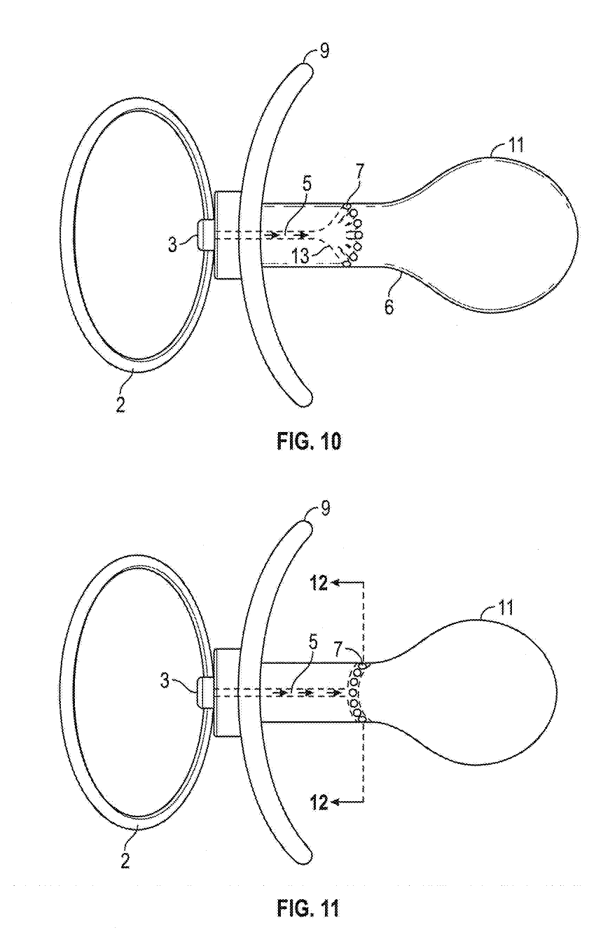

There are many different branching patterns 13 that can be used with the invention. For example, FIGS. 5, 5A and 10 show a first preferred branching pattern wherein multiple distributaries break off from a single enclosed channel or tube and end in a plurality of beveled openings 7 arranged in a substantially transverse semi-circular convex configuration (“semi-circular convex pattern”). FIG. 6 depicts a second preferred branching pattern wherein a single enclosed channel or tube breaks off into four (4) distributaries, each ending in beveled openings 7 in a substantially linear configuration (“quaternary pattern”). FIG. 7 depicts a third preferred branching pattern wherein a single enclosed channel having a beveled opening has four break offs of distributaries resulting in a total of five beveled openings arranged in a substantially linear configuration (“quinary pattern”). FIG. 11 depicts a fourth preferred branching pattern wherein a single enclosed channel is connected to a plurality of beveled openings 7 arranged in a substantially semi-circular concave pattern (“semi-circular concave pattern”).

The primary goal of the presently preferred invention is to allow for the rinsing of teeth after feedings, especially at night and middle of the night. Once a child has fallen asleep during nursing or bottle use, and while keeping the child in the same semi upright position in which the child was being fed, the device is preferably inserted into the child's mouth and the syringe is inserted into the aperture in the lip shield. The syringe is thereafter slowly depressed. It is preferable to pause during the depression so that there is no overflow of water in the child's mouth. One rinse or flush with water should be sufficient to dilute milk (or other liquids) from the teeth and other oral soft tissues. For children that swallow the water from the syringe, a second rinse or flush is preferred. For children that do not swallow the water, a bib or towel should be handy to catch any water that flows out of the child's mouth, and a second rinse should not be attempted. The same protocol can be preferably repeated at each feeding given during the night.

There are many alternative designs for the present invention, with the main difference being the different branching patterns 13 of the enclosed channels or tubes 5. The branching 13 serves the main purpose of ending in locations that will cleanse (rinse) the front teeth, but may optionally have enclosed channels that wrap around to the lateral (side) or inferior (bottom) portions of the pacifier to rinse the canines, molars, or tongue (not shown).

FIG. 13 shows another presently preferred embodiment of the invention, wherein the enclosed channels or tubes 5 are applied to a baby bottle cap. The aperture is located in the rim 4, which itself is configured to receive the cap. When a baby is close to finishing his/her milk from a bottle, water can be preferably added to the bottle via a syringe attached to an aperture 3 (or tube) on the bottle to rinse the teeth.

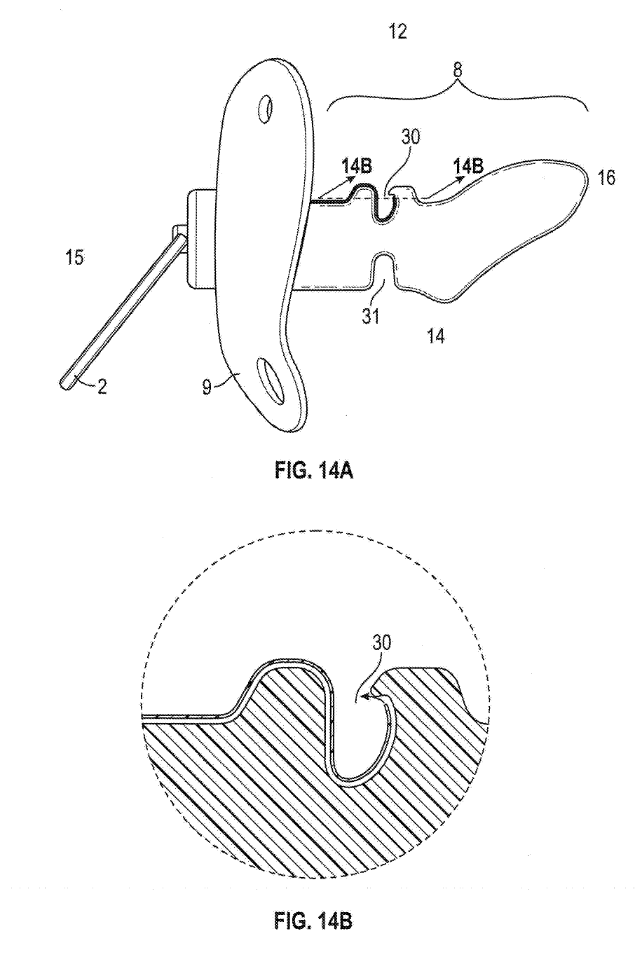

FIG. 14A is another presently preferred embodiment of the invention containing depressions or notches 30, 31 located in the body 8, in the approximate location of the upper and lower teeth when the pacifier is inserted into a child's mouth. The upper teeth preferably fit into the notch 30 located on the top 12 of the body 8, and the lower teeth fit into the notch 31 located on the bottom 14 of the body 8. The purpose of the notches is to ensure to the predictable rinsing of both the upper and lower teeth. There are multiple preferable designs of water flow through the vertical walls of the notch. FIG. 14B depicts a close-up of the notch 30 located on the top of the pacifier body for clarity purposes and provides an example of how flushing can be accomplished through enclosed channels in the vertical walls of the notch.

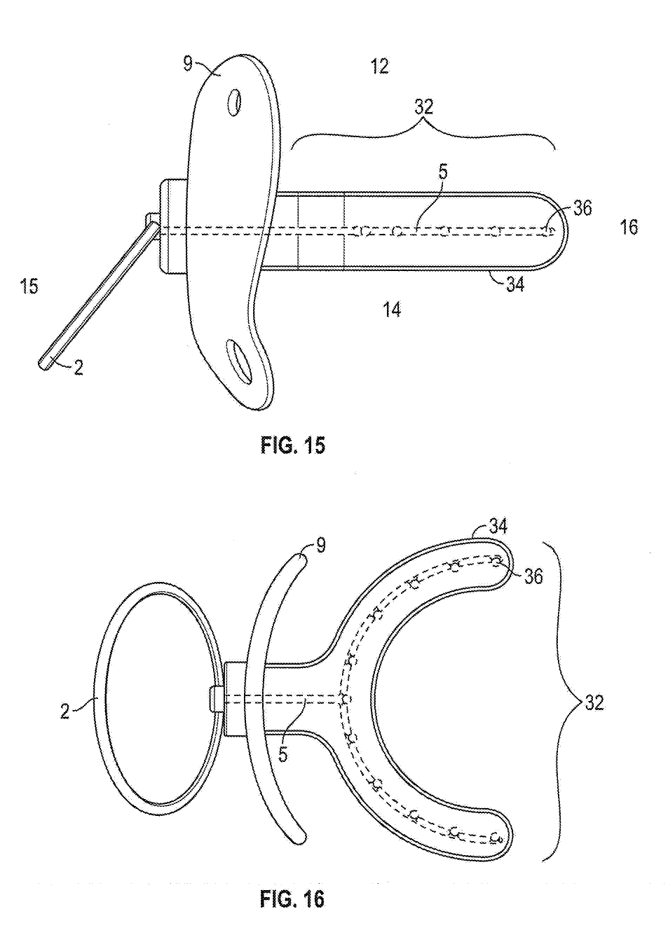

FIG. 15 is another presently preferred embodiment of the invention containing a modified rinsing design, which has a mouthpiece or retainer (mold) 32 rather than a pacifier nipple. The device uses the same concept of flushing with water, but is a better design for children ages 3 and older because more primary teeth are present at those ages. The retainer walls 34 preferably contain enclosed channels 5 which end in openings 36. The openings 36 are not beveled as in the other embodiments, but rather the openings face the top of the device. FIG. 16 is a top plan view of FIG. 15.

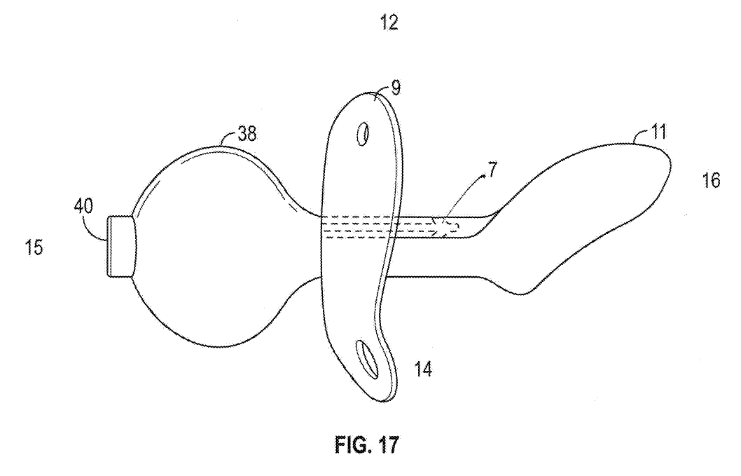

FIG. 17 is another presently preferred embodiment of the invention that uses a pacifier with a squeeze bulb 38, which can be prefilled with water by removing a plastic cap 40 on its end. When the bulb is squeezed, it will perform in the same manner as the syringe in other preferred embodiments.

While the present invention has been disclosed in connection with the presently preferred embodiments described herein, it should be understood that there may be other embodiments which fall within this spirit and scope of the invention as defined by the claims. Accordingly, no limitations are to be implied or inferred in this invention except as specifically and as explicitly set forth in the claims.

### INDUSTRIAL APPLICABILITY

This invention can be used whenever it is necessary or desirable to rinse a child's teeth and mouth after nursing or feeding to avoid tooth decay.

What is claimed is:

1. A pacifier for rinsing an infant's or child's mouth and teeth comprising:
a body having a top, a bottom, a front having a port, a back, body walls having an outer surface with beveled openings along said body walls that are angled toward said front, and enclosed channels in fluid communication between said port and said beveled openings;
a lip shield mounted on said front having an aperture connected to said port, wherein said lip shield and said body walls define an inner lumen; and
a nipple mounted on said back;
whereby when said pacifier is placed in said mouth, and water is pushed through said aperture, said water is pushed through said port, said enclosed channels and said beveled openings, and rinses said teeth.

2. A pacifier for rinsing an infant's or child's mouth and teeth comprising:
a body having a top, a bottom, a front having a port, a back, body walls having an outer surface with a first notch configured to receive said teeth along said body on said top with beveled openings in said first notch that are angled toward said front, and enclosed channels in fluid communication between said port and said beveled openings;
a lip shield mounted on said front having an aperture connected to said port, wherein said lip shield and said body walls define an inner lumen; and
a nipple mounted on said back;
whereby when said pacifier is placed in said mouth, and water is pushed through said aperture, said water is pushed through said port, said enclosed channels and said beveled openings, and rinses said teeth.

3. A pacifier according to claim 1, further comprising a tube attached to said aperture.

4. A pacifier according to claim 2, further comprising a tube attached to said aperture.

5. A pacifier according to claim 2, wherein said bottom has a second notch configured to receive said teeth.

6. A pacifier for rinsing an infant's or child's mouth and teeth comprising:
a body having a top, a bottom, a front having a port, a back, body walls having an outer surface with beveled openings along said body walls that are angled toward said front, and enclosed channels in fluid communication between said port and said beveled openings;
a lip shield mounted on said front having a bulb connected to said port, wherein said lip shield and said body walls define an inner lumen; and
a nipple mounted on said back;
whereby when said pacifier is placed in said mouth, said bulb is filled with water, and said water is squeezed through said port, said enclosed channels and said beveled openings, said water rinses said teeth.

7. A pacifier according to claim 1, 2, 3, 4, 5 or 6, wherein said enclosed channels are located entirely within said body walls, said port extends into said body walls and connects to said enclosed channels, and said beveled openings extend through said outer surface.

8. A pacifier according to claim 1, 2, 3, 4, 5 or 6, wherein said enclosed channels are located entirely on said outer surface with said beveled openings on said top.

9. A pacifier according to claim 1, 2, 3, 4, 5 or 6, wherein said enclosed channels are located entirely on said outer surface with said beveled openings on said bottom.

10. A pacifier according to claim 1, 2, 3, 4, 5 or 6, wherein said enclosed channels are branched into a branching pattern is selected from the group consisting of: semi-circular convex pattern, semi-circular concave pattern, quaternary pattern, and quinary pattern.

11. A pacifier according to claim 1, 2, 3, 4, 5 or 6, wherein said lip shield is integrally formed with said body.

12. A pacifier according to claim 1, 2, 3, 4, 5 or 6, wherein said nipple is made out of silicone.

13. A baby bottle cap for rinsing an infant's or child's mouth and teeth comprising:
a body having a top, a bottom, a front having a port, a back, body walls having an outer surface with beveled openings along said body walls that are angled toward said front, and enclosed channels in fluid communication between said port and said beveled openings;
a nipple mounted on said back; and
a rim configured to retain said cap having an aperture connected to said port, wherein said rim and said body walls define an inner lumen;
whereby when said cap is placed in said mouth, and water is pushed through said aperture, said water is pushed through said port, said enclosed channels and said beveled openings, and rinses said teeth.

14. A baby bottle cap according to claim 13, wherein said enclosed channels are located entirely within said body walls, said port extends into said body walls and connects to said enclosed channels, and said beveled openings extend through said outer surface.

15. A baby bottle cap according to claim 13, wherein said enclosed channels are located entirely on said outer surface with said beveled openings on said top.

16. A baby bottle cap according to claim 13, wherein said enclosed channels are located entirely on said outer surface with said beveled openings on said bottom.

17. A baby bottle cap according to claim 13, wherein said enclosed channels are branched into a branching pattern selected from the group consisting of: semi-circular convex pattern, semi-circular concave pattern, quaternary pattern, and quinary pattern.

18. A baby bottle cap according to claim 13, wherein said nipple is made out of silicone.

19. A device for rinsing an infant's or child's mouth and teeth comprising:
a retainer configured to receive said teeth having a top, a bottom, a front having a port, a back, retainer walls having an outer surface with openings along said retainer walls facing said top, and enclosed channels in fluid communication between said port and said openings; and
a lip shield mounted on said front having an aperture connected to said port;
whereby when said retainer is placed in said mouths, and water is pushed through said aperture, said water is pushed through said port, said enclosed channels and said openings, and rinses said teeth.

20. A device according to claim 19, wherein said enclosed channels are located entirely within said retainer walls, said port extends into said retainer walls and connects to said enclosed channels, and said beveled openings extend through said outer surface.

21. A device according to claim 19, wherein said enclosed channels are located entirely on said outer surface with said beveled openings on said top.

22. A device according to claim 19 wherein said enclosed channels are branching into a branching pattern is selected from the group consisting of: semi-circular convex pattern, semi-circular concave pattern, quaternary pattern, and quinary pattern.

23. A device according to claim 19, wherein said lip shield is integrally formed with said retainer.
